(19) United States
(12) Patent Application Publication
(10) Pub. No.: US 2026/0187635 A1
(43) Pub. Date: Jul. 2, 2026

(54) DETECTION SYSTEM AND APPLICATION USING MOTION SIGNATURE

(71) Applicant: American Express Travel Related Services Company, Inc., New York, NY (US)

(72) Inventor: Andras L. FERENCZI, Scottsdale, AZ (US)

(73) Assignee: American Express Travel Related Services Company, Inc., New York, NY (US)

(21) Appl. No.: 19/004,010

(22) Filed: Dec. 27, 2024

(51) Int. Cl. G06Q 20/40; G06Q 20/20; G06Q 20/34; G06K 19/07

(52) U.S. Cl. CPC G06Q 20/40145; G06Q 20/204; G06Q 20/352; G06K 19/0702

(57) ABSTRACT

Disclosed herein are system, method, and computer program product aspects for authentication and fraud detection of a credit card transaction. An example implementation receives an authentication request from a POS terminal to authenticate a user associated with a transaction. The implementation then obtains transaction data associated with the transaction. The implementation then receives motion data containing a movement pattern of the user from a motion sensor embedded into the credit card. The implementation then generates a current user profile associated with the user using the transaction data and the motion data. The implementation then provides the current user profile to a machine learning model to generate a response. The implementation then receives the response from the machine learning model. The implementation then transmits a request to cause the POS terminal to decline the transaction based on the user not being the owner of the credit card.

### BACKGROUND

Credit card transactions are authenticated by the credit card’s issuing bank or financial institution to verify a user’s identity and ensure the transaction is valid. Transaction authentication involves verifying that the person making the purchase is the legitimate cardholder. This can be done using something the user knows, like a password, or something they have, like a fingerprint or facial recognition.

### BRIEF DESCRIPTION OF THE FIGURES

The accompanying drawings are incorporated herein and form a part of the specification.

FIG. 1 is a workflow of authentication and fraud detection of a credit card transaction, according to aspects of the present disclosure.

FIG. 2 is a block diagram of a credit card architecture, according to aspects of the present disclosure.

FIG. 3 is a block diagram of a transaction authentication and fraud detection system, according to aspects of the present disclosure.

FIG. 4 is a block diagram of a wireless charging system, according to aspects of the present disclosure.

FIG. 5 is a flowchart illustrating a method for credit card transaction authentication and fraud detection, according to aspects of the present disclosure.

FIG. 6 is an example illustrating a workflow of authentication and fraud detection of a credit card transaction, according to aspects of the present disclosure.

FIG. 7 is an example illustrating a workflow of motion signature transmission, according to aspects of the present disclosure.

FIG. 8 is an example illustrating a workflow of motion signature collection and processing, according to aspects of the present disclosure.

FIG. 9 is an example illustrating a workflow of wireless charging of a credit card, according to aspects of the present disclosure.

FIG. 10 illustrates an example computer system useful for implementing various aspects of the present disclosure.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product aspects, and/or combinations and sub-combinations thereof, for credit card transaction authentication and fraud detection.

Implementations described herein describe a credit card transaction authentication and fraud detection system using motion signature. Credit card transaction authentication system(s) of enterprise companies such as bank holding companies, typically create unnecessary friction for legitimate customers by requiring additional steps to verify their identity. These extra steps, such as entering codes or verifying through a mobile application (hereinafter referred to as “mobile apps”), may be frustrating for users or create a negative user experience, especially for small transactions or frequent online purchases. These extra steps may also lead to potential abandoned purchases due to perceived inconvenience, especially when the authorization process is slow or cumbersome. In some instances, legitimate transactions may be flagged as suspicious due to unintended attempts in the verification process, for example, legitimate customers may have trouble remembering the password or have difficulty accessing authentication devices receiving the code. These attempts may lead to failed transactions, further frustrating the customers. In addition, technical problems may occur when the authentication process starts, for example, the authenticating message sent by the credit card issuer or third-party agency may be delayed or lost, resulting in a timeout error or a failed transaction authentication.

To tackle these technological challenges, implementations described herein describe a credit card transaction authentication and fraud detection system that uses motion signature for user authentication and/or fraud detection. For example, the motion signature may refer to user’s movement patterns, captured by motion sensors such as accelerometers, gyroscopes or motion capture systems, as a unique identifier to authenticate their identity. Since different users may have subtle differences in how they move, the motion data capturing acceleration, rotation, and joint angles of the user can be potentially distinct and usable for transaction authentication or verification purposes. Furthermore, user authentication and/or fraud detection that uses motion signature may provide a higher security level for the user authentication system. Specifically, it can be challenging to intentionally replicate a user’s exact movement pattern which requires replicating a specific sequence of body motions. This replicating, which may aim to closely mirror the form and mechanics of an observed user movement, can be complicated, especially if the movement is complex. This also requires consistent practice with conscious focus to mimic the motion movement details, making it hard to forge or replicate the user movement. In addition, unlike password or verification code, motion data can be collected naturally and passively while a user interacts with a device, making the authentication process simpler by without entering any passwords or codes and/or without performing any verification process through a mobile app.

The implementations described herein also increase portability and comfortability of using a motion sensor for authenticating a transaction. With a motion sensor embedded into a credit card, the motion sensor can be easily used since the credit card can be used for almost any transactions throughout the day in various settings. That is useful for enterprise companies in financial industry where the applications may use motion data (e.g., that contains user movement patterns) for transaction authentication. For successful authentication, these applications may require tracking, monitoring, and/or interpreting of user movement patterns over time. Embedding the motion sensor into the credit card can enable a continuous collection of motion data in natural environments and the ability to capture user movement patterns over time can be satisfied due to its portability and ability to collect data throughout any daily activities.

Implementation described herein further increase the convenience of using the credit card with the embedded motion sensor. By using a wireless charging receiver embedded into the credit card, the credit card (e.g., and the motion sensor) can be easily and automatically charged without placing them into a charging pad — the user may not need to worry about cable or plugging and unplugging of the credit card devices. Wireless charging of the credit card may also reduce the risk of electric shocks and connection failure because the credit card may not be exposed electrical connectors. In addition, wireless chargers can accommodate multiple credit cards simultaneously if they support the same charging standard. This versatility allows for charging multiple credit cards with a single charger. As such, embedding the wireless charger into the credit card, the credit card (e.g., with the motion sensor installed) may have an ability to continuously collect the user motion data without any interruptions.

These and other aspects of the present disclosure will be described in further detail below with respect to the accompanying drawings.

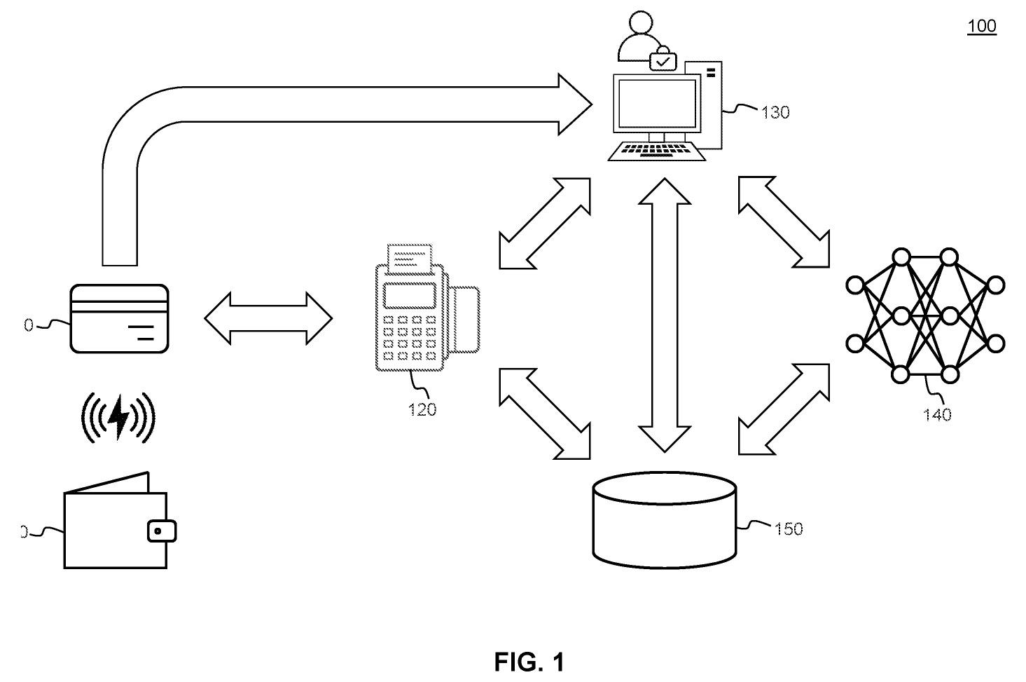

FIG. 1 is a workflow of authentication and fraud detection of a credit card transaction, according to aspects of the present disclosure. In some aspects, workflow 100 may involve several steps, including but not limited to, a transaction request, a payment transmission, a payment authentication or authorization, a payment confirmation, a transaction settlement, a merchant reporting, and/or a receipt generation. Workflow 100 may also include a wireless charging to ensure any workflow operations.

A user may provide payment information, such as a card number or bank account details, request by a merchant associated with a transaction taken place at a point of sale (POS) terminal. The user may use a credit card 110 to initialize the payment for the transaction in which the payment request may remain as initialized status until a successful charge or authentication is made within workflow 100. The payment information of credit card 110 may be encrypted and captured by a POS terminal 120. POS terminal 120 may then transmit the encrypted payment information to an authentication system 130 to verify the credit card payment and account information and then authenticate the transaction. In some aspects, authentication system 130 may be affiliated with credit card 110 or any third-party systems or agencies authorized by a bank issuing the credit card to perform this user authentication. In some aspects, the transaction may involve other data, including but not limited to, information about the time, place, and price of a transaction, as well as the payment method used and/or any discounts applied. The transaction data can also include the customer (e.g., the user) who made the purchase, the products or services purchased, and the amount spent on the purchase.

Authentication system 130 may receive user motion data along with the encrypted payment sent out from POS terminal 120. The user motion data may be captured by a motion senor embedded into credit card 110. Motion data may refer to any movement patterns of the user and can be used to verify the user’s identity before granting the user any access or authenticating the credit card payment from the user. In some aspects, authentication system 130 may be implemented at the edge in which the security or authentication mechanism with access control may be made at an edge server, typically via a content delivery network or an application programming interface (API) gateway. In some aspects, authentication system 130 may also be implemented at a local backend server. The security or authentication mechanism where the server verifies a user’s identity and access rights may be performed at a local device associated with POS terminal 120.

In some aspects, the security or authentication mechanism may be implemented at a hybrid mode with both the edge server and the local backend server. For some of the authentication requests, the local backend server can make decision without further transferring the request to the edge server. For example, the backend server can verify the user’s identity by checking any credentials provided by the user or any payment information or transaction information extracted from the encrypted payment, including but not limited to, a user signature, a user card secret key, and/or card expiration date against the card secret key. Based on the user’s information and the requested resource, the local backend server may determine if the user has necessary permissions to access that resource. However, for example, if the backend server may not authenticate the user, the payment request may be forwarded to the edge server for further determination, which may typically require a higher-level security or authentication level and/or may require additional inputs from the user (e.g., the motion data).

After receiving the motion data from credit card 110 and the encrypted payment information from POS terminal 120, authentication system 130 may call or query an external API 140 to perform any user or transaction authentication tasks. External API 140, for performing the authentication tasks, may include, but is not limited to, a statistical model, a machine learning model, a large language model (LLM), an artificial intelligence (AI) engine, and/or any other suitable models. In some aspects, to call an external API 140, authentication system 130 may use an API gateway’s endpoint uniform resource locator (URL), including but not limited to the stage name and resource path, to make a request to that URL with the necessary parameters and headers as defined in configuration of the API gateway.

In some aspects, the models at external API 140 may be trained or fine-tuned on a user database 150. User database 150 may store information about users specifically related to their transactional activities, such as purchases, payments, or other interactions within authentication system 130. As such, user database 150 may allow for tracking and analysis of each individual user’s transaction history and can be updated to incorporate any new user transaction data, either from POS terminal 120 or authentication system 130. User database 150 may also support updating of existing information, by either deleting the previous data (e.g., in a vector format) or directly modifying the existing data if user database 150 supports in-place updates.

After querying external API 140, authentication system 130 may receive the response from external API 140 that indicates whether to authenticate or decline the user associated with this transaction request. During the querying of external API 140, the bank issuing credit card 110 may send a confirmation to the POS terminal 120 or a merchant to place a hold on the payment amount related to the transaction. In some aspects, the merchant may settle a batch of transactions and corresponding funds may be deposited into the merchant account after user authentication. In addition, after the merchant or transaction settlement, the merchant and the bank may review and reconcile the transaction records and send out any report and/or receipt detailing the purchase to the user of credit card 110.

In some aspects, a wireless charging may be supported to recharge a battery of credit card 110 while it is stored in a charger wallet 160 with a built-in wireless charger. Charger wallet 160 may use electromagnetic fields to transfer energy to credit card 110 a device without a physical connection. An electrical current may pass through a coil of charger wallet 160, creating an electromagnetic field. When a receiving coil of credit card 110 comes close to the charging coil, the receiving coil may receive power from the created electromagnetic field from charger wallet 160. As such, the receiving coil may then convert the electromagnetic field into an electrical current that charges the battery of credit card 110.

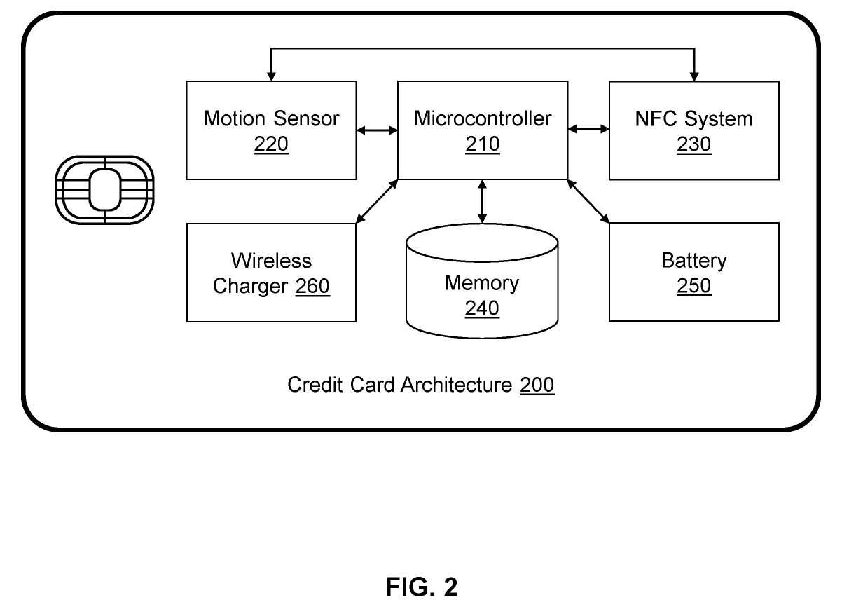

FIG. 2 is a block diagram of a credit card architecture, according to aspects of the present disclosure. In some aspects, credit card architecture 200 may include, but is not limited to, a microcontroller 210, a motion sensor 220, a near-field communication (NFC) system 230 (e.g., including an NFC chip and an NFC reader), a memory 240, a battery 250, and/or a wireless charger 260. Microcontroller 210 may be configured to interface with motion sensor 220, NFC system 230, memory 240, battery 250, and wireless charger 260. Motion sensor 220 may be configured to interface with microcontroller 210 and NFC system 230, where motion sensor 220 can communicate with NFC system 230 for any data collecting, processing, or transmitting.

As part of a credit card architecture 200, a custom integrated circuit (IC) may be designed to integrate a motion sensor 220 with at least a microcontroller 210, NFC system 230, a memory 240, and a battery 250. The design process of the custom IC may use unique building blocks that are created specifically for the functions of credit card architecture 200, including but not limited to, collecting, processing, and transmitting of the motion data at motion sensor 220. In particular, microcontroller 210 may be programmed to develop and upload software to interpret data obtained from a motion sensor 220 and perform desired functions including but not limited to detecting specific gestures or movements of the user.

In some aspects, the custom IC may be laid out to minimize the thickness and ensure it can withstand the flexing of credit card architecture 200. A motion sensor 220 may be selected as a miniature size that can be fit within the regular dimension of a credit card in the market. The types of motion sensor 220 may include, but are not limited to, accelerometers, gyroscopes, and/or magnetometer readings. Once selected, components of credit card architecture 200 may be embedded in a physical layer of a credit card using a precise machining which may create a cavity within the layer of the credit card plastic to house a motion sensor 220, a microcontroller 210, an NFC system 230 (with both an NFC chip and an NFC reader), a memory 240, and a battery 250. The components may also be securely fixed to prevent damage during use and thin, flexible wiring or printed conductive traces may be used to connect those different components. In addition, the embedded components may be enclosed with the physical layer of credit card by sealing and laminating the assembly, creating a finished credit card architecture 200 with an integrated motion sensor 220.

In some aspects, a motion sensor 220 can be designed to communicate with an NFC system 230 in credit card architecture 200. In particular, an NFC chip of NFC system 230 may act as a passive data storage element and an NFC reader of NFC system 230 may actively initiate communication, read data from the chip, and/or can potentially write new data to it within close proximity. Credit card architecture 200 with NFC capabilities may have an antenna embedded with the card body to enable the communication. In particular, a microcontroller 210 compatible with and supports NFC protocols (or with any built-in NFC functionalities) may be selected. The NFC protocols may include, but are not limited to, ISO/IEC 14443 standard used by most credit cards. In some aspects, motion sensor 220 may be connected with microcontroller 210 by using the microcontroller’s input and/or output pins to establish a connection with the motion sensor. By using this established connection, microcontroller 210 will receive data from motion sensor 220 and process the data according to the programmed instructions.

In some aspects, a software may be developed to allow and program microcontroller 210 to interpret motion data and communicate relevant information via NFC. For example, microcontroller 210 may be programmed to transmit a specific data packet to the NFC reader when certain motion data (with specific motion) is detected. NFC may adhere to the established protocols for credit card transactions. Microcontroller 210 may also be programmed to communicate with the NFC reader in a way that is compatible with existing payment terminals and infrastructure.

In some aspects, motion sensor 220 can be designed to store motion data into memory 240 over a period of time in which the time length may be depend on available memory and data collection frequency. In particular, the amount of memory required to store the designed amount of motion data may depend on factors including but not limited to sampling rate, data dimension (e.g., x, y, z axes) and data resolution. In some aspects, a data compression algorithm including but not limited to run-length encoding or delta encoding may be implemented in a firmware of microcontroller 210 to maximize the amount of data storage in memory 240 by reducing the memory needed to store repetitive or incrementally changing data. In some aspects, the motion sensor’s sampling rate may be adjusted to keep a balance between data resolution and storage duration. Typically, a lower sampling rate may allow for longer storage time but may not be able to capture dynamic movements in a short time. A higher sampling rate may capture more detailed or dynamic motion data but may quickly fill the available memory. Selecting an appropriate sampling rate for motion sensor 220 may depend on the motion dynamics that the system wants to capture. In addition, in order to maximize the data storage for memory 240, microcontroller 210 may be programed to manage its memory by using a circular buffer that may overwrite the oldest motion data when the memory is full, and/or may transfer the motion data to NFC system 230 for offloading when the credit card is read by a compatible terminal.

In some aspects, battery 250 of credit card architecture 200 may include but is not limited to a thin and flexible lithium-ion battery which may be commonly used in small or thin devices such as smart cards and wearable electronics. These lithium-ion batteries can be made as thin as 0.5 mm while can still offer a decent capacity. In some aspects, in order to prolong the battery life, any power management or power saving techniques may also be applied. For example, motion sensor 220 and microcontroller 210 can operate with the limited power available from the thin and flexible battery embedded in the card. Power-saving techniques such as putting microcontroller 210 and motion sensor 220 into a low-power sleep mode between samples may be implemented. As a result, for example, assuming a small, 10 mAh lithium-ion battery (which is about the size that could fit in a credit card) and a low-power motion sensor and microcontroller that mere consume an average of 50 uA of current, the battery could theoretically last around 200 hours.

In some aspects, credit card architecture 200 may support wireless charging of battery 250. For example, battery 250 may be charged by a wallet when the credit card is stored inside the wallet. This may involve creating a wallet with a built-in wireless charging system and adding a wireless charging receiver inside the credit card. In particular, a credit card architecture 200 may include, but is not limited to, a wireless charging receiver coil and a rectifier circuit (e.g., as part of wireless charger 260) to convert the received alternating current (AC) power into direct current (DC) power for charging battery 250 of the credit card. That is, when the credit card is placed or stored in the wallet, a charging circuitry of the wallet may activate, and a charging coil of the wallet may transmit power wirelessly to the receiver coil of the credit card. This transmitted power may then be used to recharge the battery of the credit card.

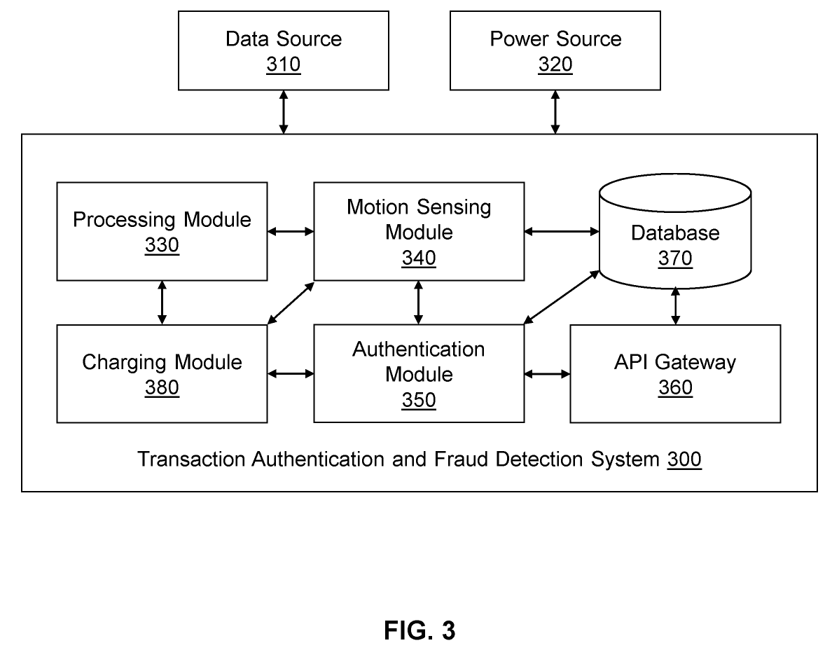

FIG. 3 is a block diagram of a transaction authentication and fraud detection system, according to aspects of the present disclosure. In some aspects, transaction authentication and fraud detection system 300 may include, but is not limited to, a processing module 330, a motion sensing module 340, an authentication module 350, an API gateway 360, a database 370, and/or a charging module 380. In some aspects, transaction authentication and fraud detection system 300 may externally connect with a data source 310 and a power source 320. Specifically, a data source 310 may refer to a location or origin where input data of transaction authentication and fraud detection system 300 may be stored or generated. The system may then access to retrieve and utilize information from data source 310 essentially, it may be the source of the data that is fed into transaction authentication and fraud detection system 300, whether it can be a database, file, web API, sensor, or another application. A power source 320 may refer to a device or mechanism that provides electrical energy to operate transaction authentication and fraud detection system 300, such as a battery, wireless charging, generator, solar panel, main power grid, and/or other energy sources, essentially the source of electricity that may fuel the system’s functions.

In some aspects, data source 310 may be a separate computing platform including but not limited to smartphones, tablet computers, laptop computers, desktop computers, web browsers, and/or other computing devices, apparatuses, systems, or platforms. In some aspects, data source 310 may transmit information to transaction authentication and fraud detection system 300 either in a wired or wireless manner and may be, for example, the Internet, a Local Area Network, or a Wide Area Network. The transmission may utilize a network protocol, such as, for example, a hypertext transfer protocol (HTTP), a transmission control protocol (TCP)/Internet protocol (IP) protocol, Ethernet, or an asynchronous transfer mode.

Transaction authentication and fraud detection system 300 may receive data from data source 310. The data from data source 310 may include, but is not limited to, any data received from a POS terminal, such an authentication request from to authenticate a user associated with a transaction and any transaction related data or details and/or any motion data received from a motion sensor embedded into the credit card, such as a movement pattern of the user. In some aspects, transaction authentication and fraud detection system 300 may receive power supports from power source 320. A power source 320 may generate electrical voltage, either via a wired charging or wireless charging, and then may drive the flow of current through a circuit to power various components within the system. For example, by a wireless charging receiver embedded into the credit card, a battery of the system may be charged based on converting received AC power into DC power.

After transaction authentication and fraud detection system 300 receives data from data source 310, processing module 330 may be triggered by data characteristics that match any predefined criteria to analyze contexts and/or types of the data. These criteria may be determined based on a list of factors, including but not limited to, types of data input, the system capabilities, the computational resource, and/or any transmission effects. Processing module 330 may, based on the criteria, process data from data source 310 to extract information that can be used for any subsequent analysis and evaluation. In some aspects, a data processing module 330 may perform processing operations to the data, including but not limited to, removing data noise, filtering redundant data, converting data format, and/or enhancing data quality.

After processing module 330 processes data, it may transmit the processed data to a motion sensing module 340. In some aspects, motion sensing module 340 may directly receive motion data from data source 310. In some aspects, motion sensing module 340 may be configured to perform a set of steps to process motion data, including but not limited to, pre-processing the motion data by cleaning, filtering, and segmenting it based on relevant movement events or patterns (e.g., specific gesture or a walking style of the user), and/or applying feature extraction techniques to identify key characteristics of the motion, which can then be used for activity recognition, gait analysis, fall detection, or other movement-related applications.

In some aspects, as preprocessing of the motion data, motion sensing module 340 may remove noise and outliers from the raw motion data using filtering techniques (e.g., low-pass, high-pass filters). Motion sensing module 340 may also segment and/or divide the continuous data stream into meaningful segments based on movement events (e.g., step detection in walking). In addition, motion sensing module 340 may convert raw motion data to a consistent coordinate system. In some aspects, as feature extraction, motion sensing module 340 may extract time-domain features directly from the raw motion data, such as extracting mean, standard deviation, signal energy, and/or zero-crossing rate. Motion sensing module 340 may also extract frequency-domain features from the frequency spectrum of the motion data. In additional, some other features, including but not limited to, peak acceleration, joint angles (e.g., calculated from the raw motion data using biomechanical models), and gait parameters (e.g., stride length, cadence) may be extracted by motion sensing module 340. In some aspects, as activity recognition, motion sensing module 340 may use any suitable machine learning models or algorithms (e.g., support vector machines, neural networks, decision trees, deep learning, etc.) based on the complexity of the user movement and the desired accuracy.

After processing module 330 processes the transaction data and motion sensing module 340 processes the motion data, the processed transaction data and processed motion data may be transmitted to an authentication module 350. In some aspects, authentication module 350 may analyze the processed transaction data and/or the processed motion data to identify any fraudulent features associated with the transaction. For example, the fraudulent features may refer to any characteristics or details within a financial transaction that indicates it is likely to be unauthenticated or deceptive, including but not limited to, an unusual purchase location, a large, sudden purchase amount, or using stolen payment information, all of which can signal potential fraud. Authentication module 350 may then, based on the identifying fraudulent features, transmit a request to cause the POS terminal to decline the transaction.

In some aspects, authentication module 350 may also authenticate and verify the user identity using the processed motion data that may contain user movement patterns captured by the motion sensor. Authentication module 350 may identify unique user characteristics and grant access based on the identification, especially acting as a form of continuous user authentication where the user’s actions (e.g., transactions requests) are constantly monitored for verification purposes. In some aspects, authentication module 350 may query or call one or more external machine learning models (e.g., LLMs) to perform this user authentication. By performing this, authentication module 350 may call the one or more machine learning models via an API gateway 360. For example, authentication module 350 may provide, via API gateway 360, the current user profile that combines both the processed transaction data from data processing module 330 and the processed motion data from motion sensing module 340 to the one or more machine learning models (e.g., at cloud or remote server). When the current user profile is provided to the one or more machine learning models by authentication module 350, the current user profile may be analyzed by the trained models to determine if the current user profile matches the profile of a recognized user (e.g., the owner of the credit card).

In some aspects, the one or more machine learning models may be trained on a database 370 including, but not limited to, labeled historical motion data from the owner of the credit card to understand the distinct movement patterns associated with the owner. In some aspects, database 370 may also include, but is not limited to, any historical transaction data that may be associated with the movement data of the owner. Training of the machine learning models may also be supplemented by adding the historical transaction data of the owner as a context. Such context may refer to surrounding information or transaction background details that may help interpret and understand the motion data points within database 370, allowing a machine learning model to make more accurate predictions by considering the relevant factors beyond the motion data itself. For example, a time period, a geographic location, any user past actions or preferences of the motion data, and/or any other relevant items can be a critical context. In some aspects, the machine learning models may be trained from different users to learn the distinct patterns associated with each person and learn the difference of those patterns between different users — that in this case, database 370 may include the user characteristic patterns labeled for more than one user.

In some aspects, a first machine learning model may be queried to analyze the transaction data to understand the transaction behaviors. A second machine learning may then be query to analyze the motion data when the first machine learning model may not be able to get an exact authentication result. This cascade of the first and the second machine learning model may provide a more adaptive and robust security approach compared to using a single model. In some aspects, these machine learning models may be trained from various modalities, combining data from multiple sources, for example, text or image data from transaction terminal and motion data from the motion sensor, and that utilize different sensing methods to create a more complete and accurate understanding of the user identity by leveraging the complementary strengths of each modality, overcoming limitations of individual data source, and achieving better perception in complex situations.

In some aspects, based on using database 370, the one or more machine learning models can be trained from scratch, can be fine-tuned (e.g., training a pre-trained model), or can be trained using a reinforcement learning approach. In some aspects, the one or more machine learning models may also be any pre-trained model (e.g., a LLM model, an inception model, any embedding models, etc.) that has been trained on a large dataset and can be directly used without fine-tuning. In addition, in some aspects, the one or more machine learning models may be trained using an unsupervised learning approach in which an unlabeled database (e.g., as part of a database 370) that incorporates the characteristics of at least the transaction data or the motion data may be used.

After the machine learning models receive the current user profile that combines both the processed transaction data from data processing module 330 and the processed motion data from motion sensing module 340, a first embedding associated with the current user profile and a second embedding associated with any historical transaction data or motion data of the owner may be generated. The machine learning models may calculate a distance metric between the first embedding and the second embedding, and then identify whether the user is the owner of the credit card based on determining the distance metric within a threshold — that is, the current user profile or behavior is compared to the learned patterns by the machine learning model, and a decision is made to grant or deny access based on the distance. In some aspects, both the first and second embedding may be generated using an embedding model pre-trained on database 370 in which the second embedding may be the learned pattern by the machine learning. In addition, the one or more machine learning models may transmit the decision (e.g., either to grant or deny access of the transaction) back to authentication module 350 via API gateway 360. Authentication module 350 may then transmit the decision as a request back to the POS terminal to approve or decline the transaction.

In some aspects, database 370 may support adding current user profile from authentication module 350 when the current user profile is authenticated as the owner — appending the current user profile to data records associated with the owner. Database 370 may also support deleting of the previous data if the previous data is expired — to remove any data from a system that has reached its designated expiration date, essentially cleaning up old or outdated information that is no longer considered relevant or valid according to set rules for user authentication or retention policies. In addition, database 370 may support in-place data update or modification in which the values of existing data in database 370 may be updated by specifying an area of the data to be updated, a condition for which the data update will be performed, and/or a new value to assign to the data. In some aspects, when new motion data is generated for a new user, motion sensing module 340 may directly save the new motion data into database 370 when this new motion data can be identified to associate with the owner. Accordingly, processing module 330 may also save the new transaction data associated with the new motion data into database 370. In some aspects, any default user profiles prepared at any initialization procedures related to the user when opening the credit card account may be added to database 370 to associate with the owner, if the database does not contain any historical user profiles for the owner. The default user profiles can be treated as foundational data for database 370 associated with the owner to function properly in which those default user profiles may include necessary tables, columns, or any initial data values when a new database associated with the owner is created or when an application is first deployed.

In some aspects, a charging module 380 may be configured to recharge the battery to support operating of transaction authentication and fraud detection system 300. In particular, charging module 380 may interface with processing module 330, motion sensing module 340 and/or authentication module 350 to conduct transaction authentication and fraud detection. In some aspects, charging module 380 may include a wireless charging module which uses an electromagnetic field to transfer energy between a charging station and a device. Energy may be sent through an inductive coupling to an electrical device, which can then use that energy to charge batteries or run the device.

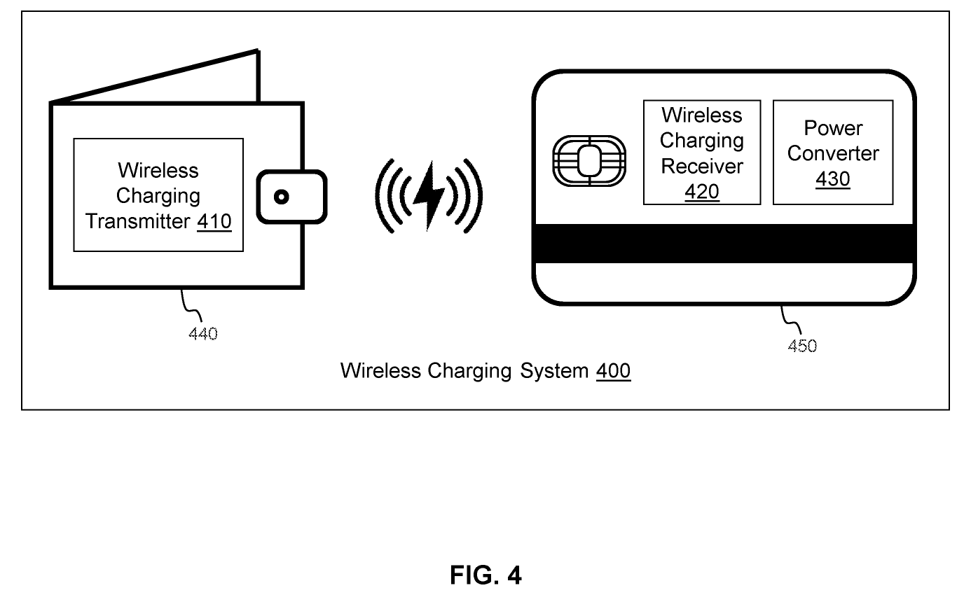

FIG. 4 is a block diagram of a wireless charging system, according to aspects of the present disclosure. In some aspects, wireless charging system 400 may include, but is not limited to, a charger wallet 440 and a credit card 450. In particular, the wireless charging may be conducted between a wireless charging transmitter 410 of charger wallet 440 and a wireless charging receiver 420. A power converter 430 may be used to convert received AC power into a DC power for charging the battery of credit card 450.

In some aspects, charger wallet 440 may integrate a wireless charging transmitter 410 in which a wireless charging coil of the transmitter may be embedded into a card slot or in a dedicated compartment of charger wallet 440. This charging coil may also be connected to a battery and a charging circuitry within charger wallet 440. In some aspects, credit card 450 may integrate a wireless charging receiver 420 in which a wireless charging receiver coil of the receiver and a rectifier circuit of a power converter 430 may be embedded into credit card 450. Power converter 430 may be configured to convert the received AC power into DC power for charging the battery of the credit card. During the wireless charging, the charging coil in charger wallet 440 and the receiver coil in credit card 450 may be closely aligned for optimal power transfer — the closer the coils are, the stronger the magnetic field and the more efficient the power transfer can be. When credit card 450 is placed in the charging coil of charger wallet 440, the charging circuitry of the wallet activates and the charging coil transmits power wirelessly to receiver coil of the credit card. This transmitted power may be converted from AC to DC and be used to recharge the battery of credit card 450.

In some aspects, the built-in batteries of charger wallet 440 may be recharged using a standard wired connection, such as a universal aerial bus (USB) cable, or another wireless charging method. The built-in batteries may allow charger wallet 440 to store energy for later use.

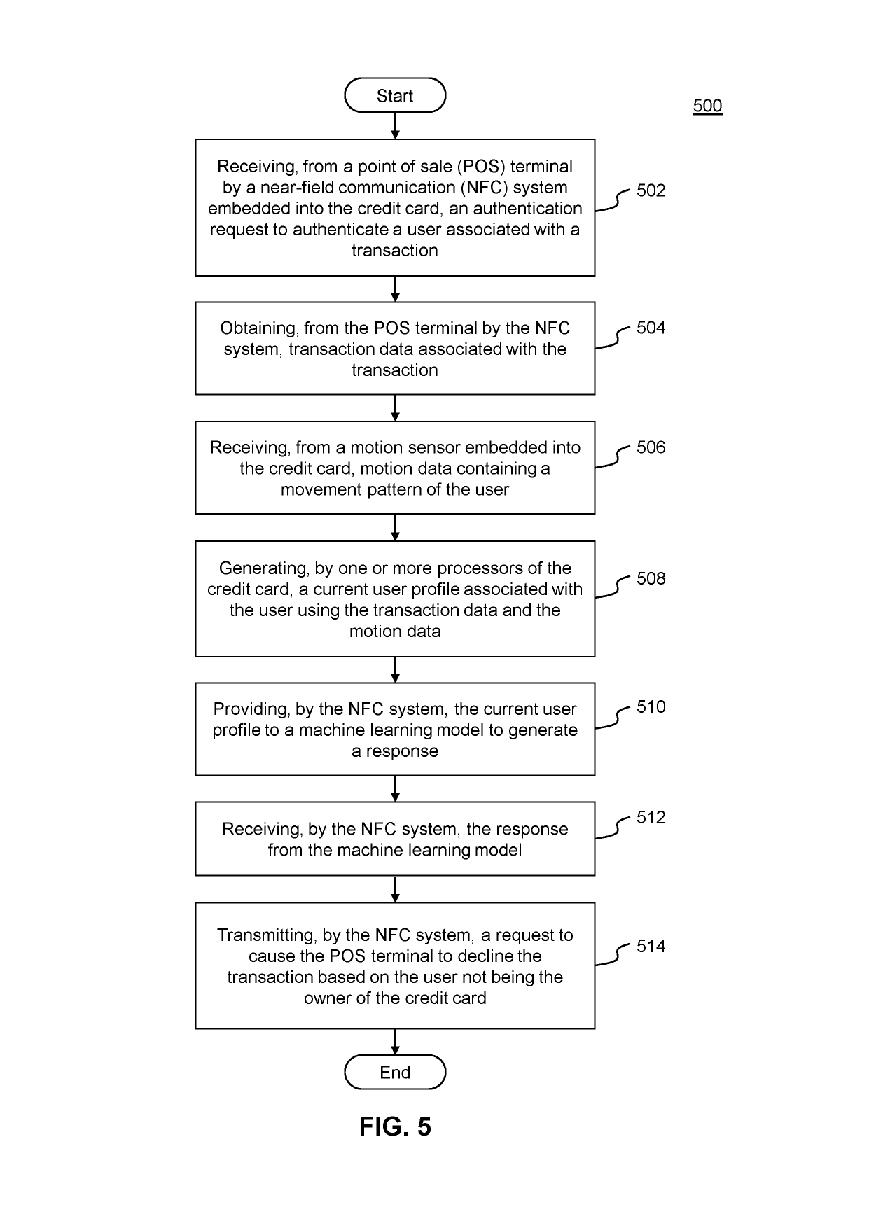

FIG. 5 is a flowchart illustrating a method for credit card transaction authentication and fraud detection, according to aspects of the present disclosure. Method 500 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 5, as will be understood by a person of ordinary skill in the art.

Method 500 shall be described with reference to at least FIGS. 1–4. However, method 500 is not limited to those example aspects.

In 502, an authentication request from a point of sale (POS) terminal may be received to authenticate a user associated with a transaction in which the transaction occurs when the POS terminal receives credit card information associated with the transaction.

In 504, transaction data associated with the transaction may be obtained in which the transaction data may include, but is not limited to, a collection of transaction details associated with the transaction. In some aspects, transaction data may include information about the time, place, and price of a transaction, as well as the payment method used and/or any discounts applied. The transaction data can also include the customer (e.g., user) who made the purchase, the products or services purchased, and the amount spent. In some aspects, the transaction data may be analyzed to identify a fraudulent feature associated with the transaction. Rather than further processing, a request (e.g., early stop or decline request) may be transmitted to the POS terminal to decline the transaction if any fraudulent features are detected.

In 506, motion data containing a movement pattern of the user may be received from a motion sensor embedded into the credit card. In some aspects, the motion data may be analyzed to identify, as the movement pattern, a specific gesture or a walking style of the user. In some aspects, motion data may also include information collected by the motion sensor such as accelerometers and gyroscopes embedded within the credit card, which capture details about the user’s movement, including acceleration, angular velocity, and orientation, allowing for tracking of activities like walking, running, sitting, or even detecting falls.

In 508, a current user profile associated with the user may be generated using the transaction data and the motion data. In some aspects, the current user profile may refer to a collection of information that can define a user’s identity and preferences associated with the transaction, including but not limited to, personal details, such as name, address, and phone number, account settings, customization options, activity history, and/or registry and configuration settings.

In 510, the current user profile may be provided to a machine learning model to generate a response in which the machine learning model may be trained on a database storing a historical user profile associated with an owner of the credit card. The historical user profile may include, but is not limited to, historical transaction data and a historical movement pattern of the owner.

In some aspects, the transaction data may be provided to a first machine learning model to understand a transaction behavior of the user. When the first machine learning model may not return an exact authentication result, the motion data may then be provided to a second machine learning model to analyze the movement pattern of the user. This cascade of the first and the second machine learning model may provide a more adaptive and robust security approach compared to using a single machine learning model.

In some aspects, a first embedding associated with the current user profile may be generated while providing the current user profile to the machine learning model. A second embedding associated with the historical user profile may also be generated. A distance metric between the first embedding and the second embedding may also be calculated. In addition, the user may be identified as the owner of the credit card based on determining the distance metric within a threshold. In some aspects, the first and the second embedding may be generated using an embedding model which may be pre-trained on the database.

In 512, the response from the machine learning model may be received in which the response may indicate whether the user is the owner of the credit card.

In 514, a request may be transmitted to cause the POS terminal to decline the transaction based on the response indicating that the user is not the owner of the credit card.

In some aspects, historical user profile in the database may need an update over a period of time. As such, whether the database contains the historical user profile associated with the owner of the credit card may be determined. In response to this determining, the current user profile may be added to the database based on the database containing the historical user profile, and otherwise, a default user profile associated with the owner of the credit based may be added to the database based on the database not containing the historical user profile. In particular, the current user profile may only be added to the database when the user is identified as the owner of the credit card.

In some aspects, a battery of the credit card may be charged by a wireless charging receiver embedded into the credit card. When the credit card is placed in a wireless charging coil, a charging circuitry activates and the wireless charging coil transmits power to a receiver coil of the credit card. The battery of the credit card may then be charged based on converting a received AC power into a DC power.

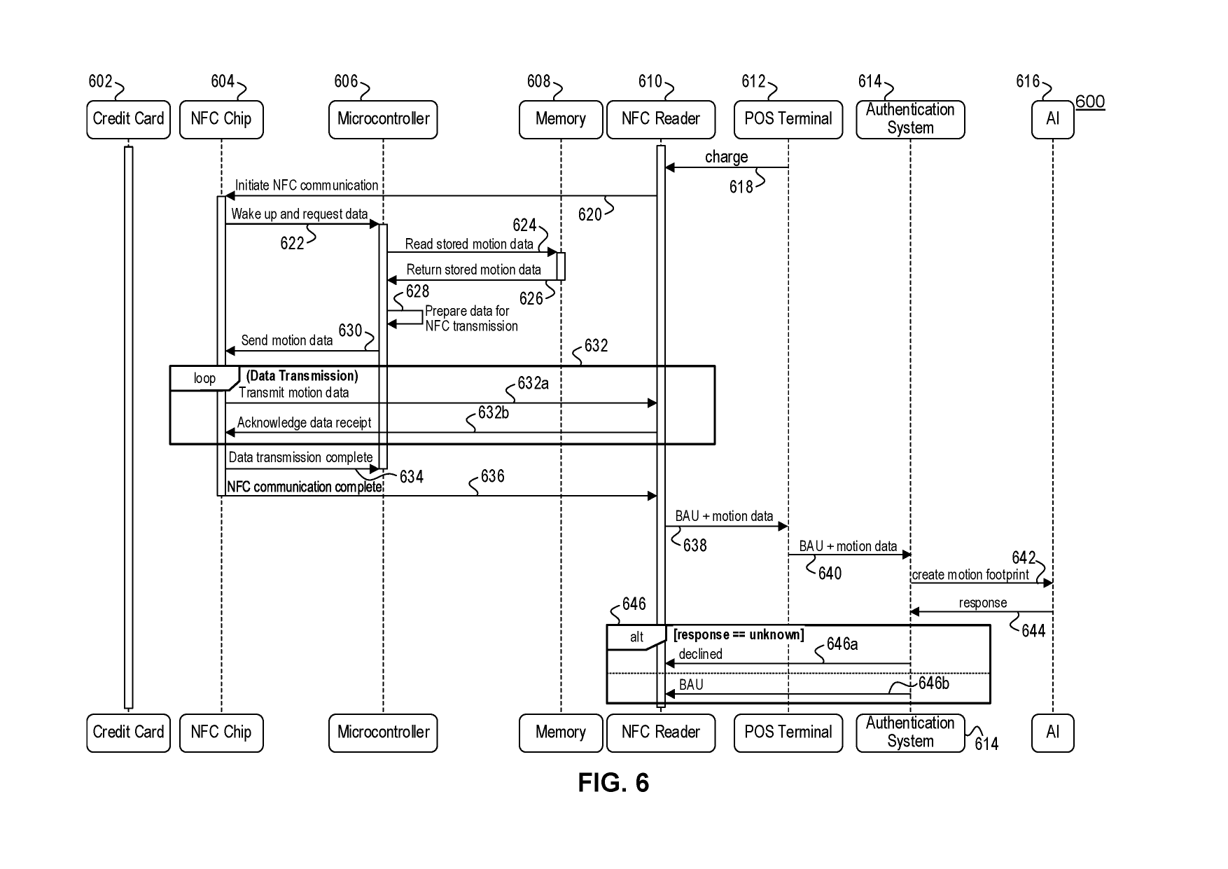

FIG. 6 is an example illustrating a workflow 600 of credit card transaction authentication and fraud detection, according to aspects of the present disclosure. FIG. 6 shall be described as an aspect of a workflow 100 of authentication and fraud detection of a credit card transaction, as illustrated in FIG. 1. However, workflow 600 is not limited to that aspect. As an example, workflow 600 may involve connecting different entities to enable credit card transaction authentication and fraud detection. These entities may include, but is not limited to, a credit card 602, a POS terminal 612, an NFC chip 604, an NFC reader 610, a microcontroller 606, a memory 608, an authentication system 614, and/or an AI 616. In some aspects, an NFC chip 604, an NFC reader 610, a microcontroller 606, and a memory 608 are embedded into credit card 602.

In 618, when POS terminal 612 sends a request to charge a credit card 602, NFC reader 610, as part of the credit card, may receive this request. In some aspects, in order to verify whether the request has been actually sent out by the owner (or an authenticated user) of credit card 602, a credit card transaction authentication and fraud detection associated with the request may be performed.

In 620, an NFC communication may be initiated between NFC reader 610 and NFC chip 604 in which the NFC communication may use radio frequency identification to transmit data within a short range of distance.

In 622, for performing this user communication, an NFC chip 604 may be activated and may send out a data request to a microcontroller 606.

In 624, after receiving the data request from NFC chip 604, microcontroller 606 may read or retrieve stored motion data from a memory 608 by specifying a memory address and request a read operation, accessing the motion data at that address for usage.

In 626, after receiving the read or retrieval operation, memory 608 may return this stored motion data back to microcontroller 606.

In 628, after receiving the stored motion data, microcontroller 606 may prepare motion data for an NFC transmission between two devices that may both have NFC chips and/or NFC readers installed. In some aspects, the motion data may be exchanged in NFC data exchange format for the transmission, making the data easily readable by most NFC-enabled devices.

In 630, after preparing the motion data, microcontroller 606 may transmit the motion data to an NFC chip 604.

In 632, while continuously receiving the prepared motion data, NFC chip 604 may also, in parallel to the receiving, transmit the motion data to an NFC reader 610. In some aspects, the data transmission between NFC chip 604 and NFC reader 610 may be performed within a loop for multiple times. For example, in 632a, NFC chip 604 may transmit the motion data to NFC reader 610. In 632b, NFC reader 610 may acknowledge a data receipt (e.g., transmit an acknowledge message) back to NFC chip 604.

In 634, after data transmission between NFC chip 604 and microcontroller 606 is complete, NFC chip 604 may send a specific signal or code at the end of a data stream to microcontroller 606 which indicates that the transmission of motion data is complete. This signal or code may also signify to microcontroller 606 that all motion data has been sent and the transmission is finished; this can be a dedicated end-of-transmission flag, a specific bit pattern, and/or a checksum to verify data integrity depending on the communication protocol being used.

In 636, after the NFC communication between NFC chip 604 and NFC reader 610 is complete (e.g., the receiving device successfully reads the data transmitted from the sending device), NFC reader 610 may indicate the completeness by using a visual or audible cue, signifying that the NFC communication is finished and the devices can be separated as they are no longer required to be in this close proximity for further communication.

In 638, NFC reader 610 may then transmit, back to POS terminal 612, the motion data and/or any other relevant data, for example, business as usual (BAU) data, to verifying the transaction request. The BAU data may be generated by BAU applications that can be analyzed to gain insights (e.g., business’s performance, customer behavior, operational trends, etc.) associated with the transaction request. In some aspects, the relevant data may include, but is not limited to, details about transactions, inventory updates, customer information, or other information to synchronize the transaction authentication system with POS terminal 612 to ensure accurate recordkeeping.

In 640, POS terminal 612 may, to authenticate or verify the request, transmit the motion data and the other relevant data (e.g., BAU data) to an authentication system 614.

In 642, authentication system 614 may create a motion footprint based on the motion data and the relevant data. In some aspect, a motion footprint may be used to analyze and synthesize the motion data by examining the sequence of footprints left by a moving figure. This created motion footprint may then be transmitted to an AI 616 for performing any user or payment authentication or verification purposes.

In 644, AI 616 may generate a response that indicates whether the request has been actually sent out by the owner (or an authenticated user) of credit card 602. AI 616 may send this response back to authentication system 614. In some aspects, either authentication system 614 or AI 616 can be hosted in an edge serve or a local backend server depending on the system capability and resources.

In 646, authentication system 614 may send the response back to NFC reader 610. For example, in 646a, when the response indicates that the user is the owner or an authenticated user of credit card 602, authentication system 614 may transmit the response back to NFC reader 610 to cause POS terminal 612 to approve the transaction request. Otherwise, when the response indicates that the user is not the owner or an authenticated user of credit card 602, authentication system 614 may hence transmit the response back to NFC reader 610 to cause POS terminal 612 to decline the transaction request. In 646b, the relevant data may also be sent back to NFC reader 610 as part of the response.

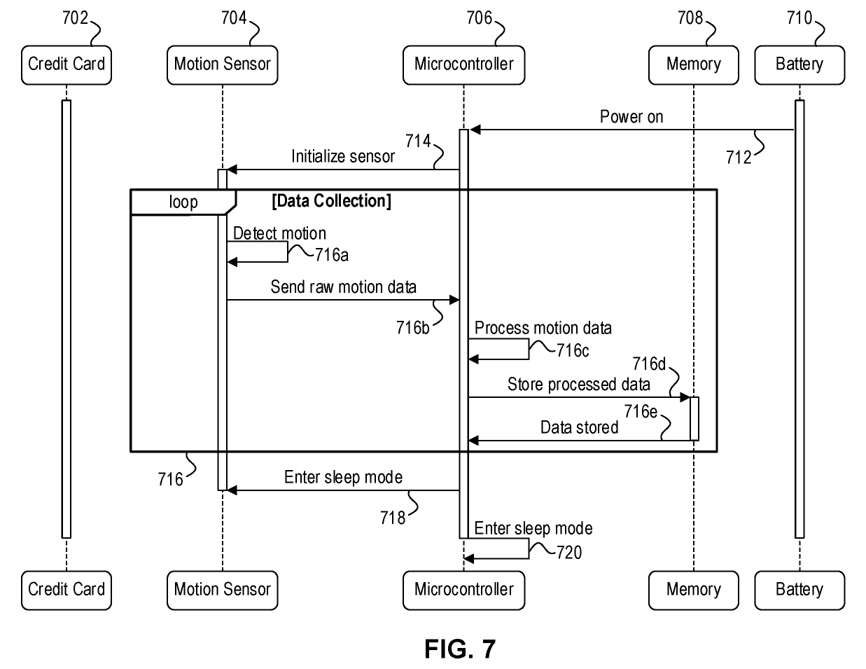

FIG. 7 is an example illustrating a workflow 700 of motion signature transmission, according to aspects of the present disclosure. FIG. 7 shall be described as an aspect of a workflow 100 of authentication and fraud detection of a credit card transaction, as illustrated in FIG. 1. However, workflow 700 is not limited to that aspect. As an example, workflow 700 may involve connecting different entities to enable motion signature transmission. These entities may include, but is not limited to, a credit card 702, a battery 710, a motion sensor 704, a microcontroller 706, and/or a memory 708. In some aspects, a motion sensor 704, a microcontroller 706, a memory 708 and a battery 710 are all embedded into credit card 702.

In 712, when microcontroller 706 is powered on by connecting with a battery 710, microcontroller 706 may go through a structured process to prepare for operation. In some aspects, this structured process may include, but is not limited to, a power-on reset to ensure microcontroller 706 to start in the same state each time is it powered on, an oscillator start-up to address any signal delay, and/or an application initialization.

In 714, microcontroller 706 may initialize setup of motion sensor 704. In some aspects, the motion sensor initialization may include, but is not limited to, adjusting any sensitivity and activation time settings on the motion sensor itself to desired parameters.

In 716, a collection of motion data may be performed between motion sensor 704 and microcontroller 706 within a look for multiple times. For example, in 716a, motion sensor 704 may detect motion of the user. In 716b, motion sensor 704 may send the raw motion sensor to microcontroller 706. In 716c, microcontroller 706 may process the sent motion data. In 716d, microcontroller 706 may store the processed motion data into a memory 708. In 716e, after memory 708 successfully stores the processed motion data, memory 708 may send a specific signal or code to microcontroller 706 which indicates that the data is completely stored.

In 718, after the data is stored into a memory 708, microcontroller 706 may send a command to motion sensor 704 in which the command may enable the motion sensor to enter a sleep mode. In some aspects, microcontroller 706 may shut down or power off a motion sensor 704.

In 720, after making motion sensor 704 enter a sleep mode, microcontroller 706 may also enter sleep mode or be powered off. In some aspects, microcontroller 706 may enter a sleep mode by setting a specific bit within a dedicated sleep mode control register, and then executing a special instruction such as SLEEP.

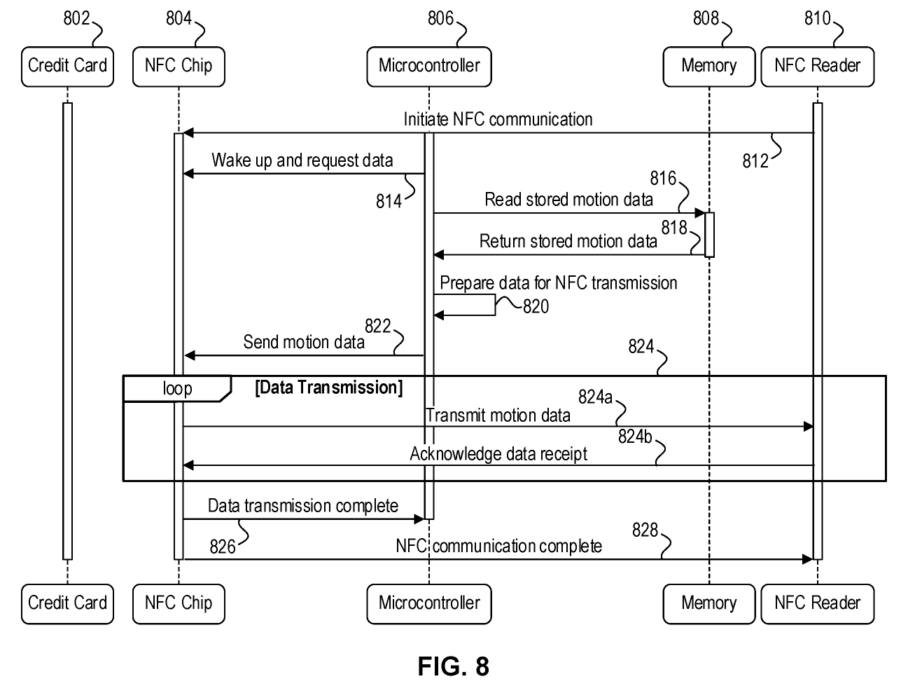

FIG. 8 is an example illustrating a workflow 800 of motion signature collection and processing, according to aspects of the present disclosure. FIG. 8 shall be described as an aspect of a workflow 100 of authentication and fraud detection of a credit card transaction, as illustrated in FIG. 1. However, workflow 800 is not limited to that aspect. As an example, workflow 800 may involve connecting different entities to enable motion signature collection and processing. These entities may include, but is not limited to, a credit card 802, an NFC chip 804, an NFC reader 810, a microcontroller 806, and/or a memory 808. In some aspects, an NFC chip 804, an NFC reader 810, a microcontroller 806, and/or a memory 808 are all embedded into credit card 802.

In 812, an NFC communication may be initiated between NFC reader 810 and NFC chip 804 in which the NFC communication may use radio frequency identification to transmit data within a short range of distance.

In 814, for performing this user communication, an NFC chip 804 may be activated and may then send out a data request to a microcontroller 806.

In 816, after receiving the data request from NFC chip 804, microcontroller 806 may read or retrieve stored motion data from a memory 808 by specifying a memory address and request a read operation, accessing the motion data at that address for usage.

In 818, after receiving the read or retrieval operation, memory 808 may return this stored motion data back to microcontroller 806.

In 820, after receiving the stored motion data, microcontroller 806 may prepare motion data for an NFC transmission between two devices that may both have NFC chips installed. In some aspects, the motion data may be exchanged in NFC data exchange format for the transmission, making the data easily readable by NFC-enabled devices.

In 822, after preparing the motion data, microcontroller 806 may transmit the motion data to an NFC chip 804.

In 824, while continuously receiving the prepared motion data, NFC chip 804 may also, in parallel to the receiving, transmit the motion data to an NFC reader 810. In some aspects, the data transmission between NFC chip 804 and NFC reader 810 may be performed within a loop for multiple times. For example, in 824a, NFC chip 804 may transmit the motion data to NFC reader 810. In 824b, NFC reader 810 may acknowledge a data receipt (e.g., transmit an acknowledge message) back to NFC chip 804.

In 826, after data transmission between NFC chip 804 and microcontroller 806 is complete, NFC chip 804 may send a specific signal or code at the end of a data stream to microcontroller 806 which indicates that the transmission of motion data is complete. This signal or code may also signify to microcontroller 806 that all motion data has been sent and the transmission is finished; this can be a dedicated end-of-transmission flag, a specific bit pattern, and/or a checksum to verify data integrity depending on the communication protocol being used.

In 828, after the NFC communication between NFC chip 804 and NFC reader 810 is complete (e.g., the receiving device successfully reads the data transmitted from the sending device), NFC reader 810 may indicate the completeness by using a visual or audible cue, signifying that the NFC communication is finished and the devices can be separated as they are no longer required to be in this close proximity for further communication.

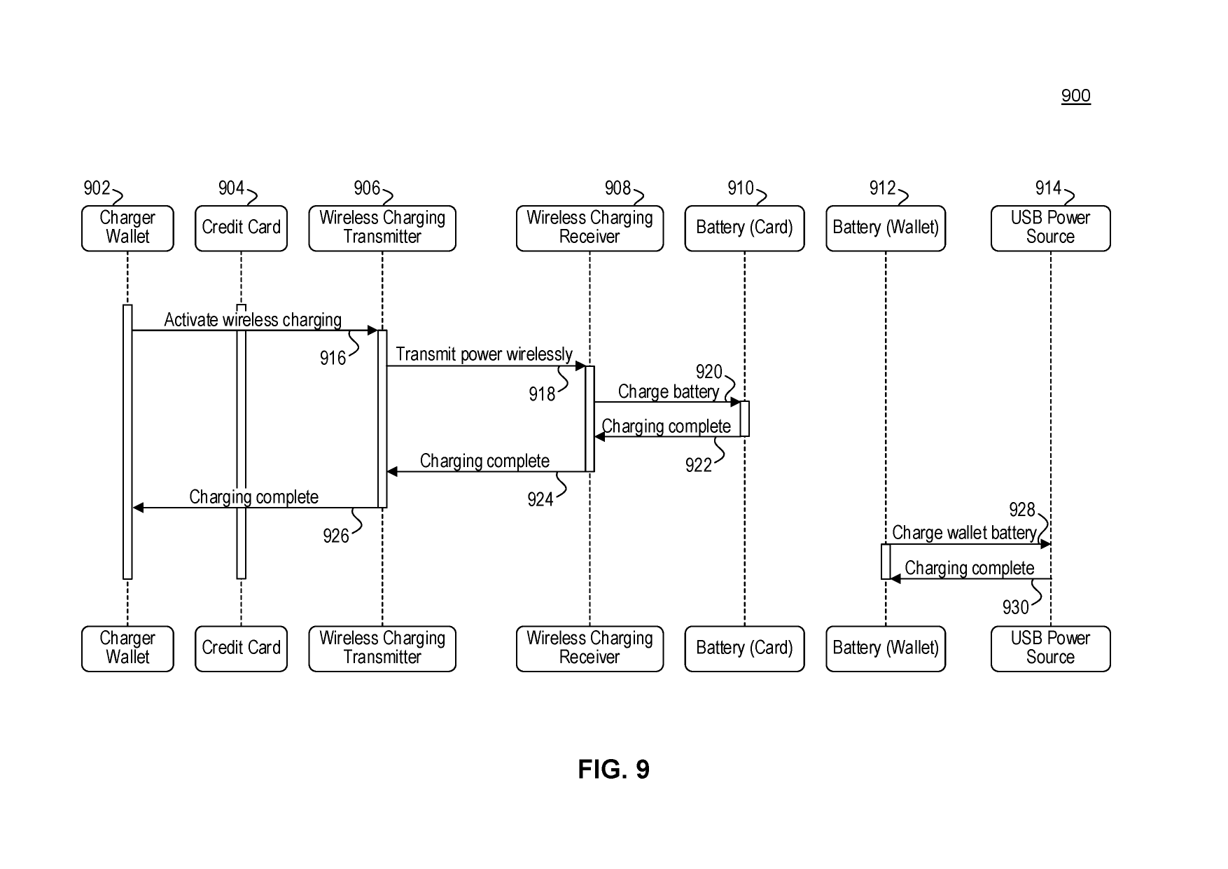

FIG. 9 is an example illustrating a workflow 900 of wireless charging of a credit card, according to aspects of the present disclosure. FIG. 9 shall be described as an aspect of a workflow 100 of authentication and fraud detection of a credit card transaction, as illustrated in FIG. 1. However, workflow 900 is not limited to that aspect. As an example, workflow 900 may involve connecting different entities to enable wireless charging of the credit card. These entities may include, but is not limited to, a charger wallet 902, a credit card 904, a wireless charging transmitter 906, a wireless charging receiver 908, a card battery 910, a wallet battery 912, and/or a USB power source 914. In some aspects, a wireless charging transmitter 906 and a wallet battery 912 may be embedded into charger wallet 902. In some aspects, a wireless charging receiver 908 and a card battery 910 may be embedded into credit card 904.

In 916, when charger wallet 902 activates wireless charging, wireless charging transmitter 906 may be activated. In some aspects, wireless charging transmitter 906 may start a pairing mode to identify wireless charging receiver 908. The pairing may be accompanied by a visual indicator such as a flashing light on wireless charging transmitter 906 to confirm activation.

In 918, wireless charging transmitter 906 may transmit power wireless to wireless charging receiver 908. In some aspects, wireless charging transmitter 906 may generate a magnetic field using a coil of wire in which the coil may then induce a current in a receiver coil within wireless charging receiver 908. Wireless charging transmitter 906 may transfer electrical power wirelessly through electromagnetic induction, allowing the receiver coil of a wireless charging receiver 908 to capture the energy.

In 920, after receiving the electrical power, wireless charging receiver 908 may convert it back into electricity to charge card battery 910. In some aspects, the electrical power may be converted from AC power to DC power based on using diodes. The diodes may allow current to flow only in one direction, transforming AC input into a pulsating DC output. This DC output may then be smoothed out by a filter circuit, typically using capacitors, to produce a steady DC voltage for use in electronic devices.

In 922, when wireless charging is complete, the charge level of card battery 910 may indicate the battery is full. In some aspects, wireless charging receiver 908 may detect when the battery capacity is full by monitoring the electrical current flowing to card battery 910. For example, when the current drops significantly which indicates the battery is nearing full, the wireless charging receiver 908 may reduce power delivery and eventually stop charging. In some aspects, this monitoring functionality may be managed by a built-in chip within wireless charging receiver 908 that may communicate with a management system of card battery 910 to determine the charge level.

In 924, when wireless charging is complete, wireless charging receiver 908 may send a signal to wireless charging transmitter 906 that indicates the battery is full and the power delivery should be reduced or stopped once the battery reaches full capacity. In some aspects, wireless charging receiver 908 may communicate to wireless charging transmitter 906 that card battery 910 is full by sending a signal through a communication protocol using amplitude shift keying modulation. Wireless charging transmitter 906 may demodulate the signal sent by wireless charging receiver 908 to understand the battery status and adjust power output accordingly.

In 926, wireless charging transmitter 906 may shut down or power off the charger wallet 902 when the charging is complete or the power delivery stops.

In 928, USB power source 914 may charge wallet battery 912 in which wallet battery 912 may then be used to recharge charger wallet 902. In some aspects, wallet battery 912 can be charged or recharged using a standard wired connection, such as a USB cable or even another wireless charging method. Wallet battery 912 may allow charger wallet 902 to store energy for later use.

In 930, when charging of wallet battery 912 is complete, the charge level of wallet battery 912 may indicate the battery is full. In some aspects, USB power source 914 may detect when a battery capacity is full by monitoring the electrical current flowing to wallet battery 912. For example, when the current drops significantly which indicates the battery is nearing full, USB power source 914 may reduce power delivery and eventually stop charging.

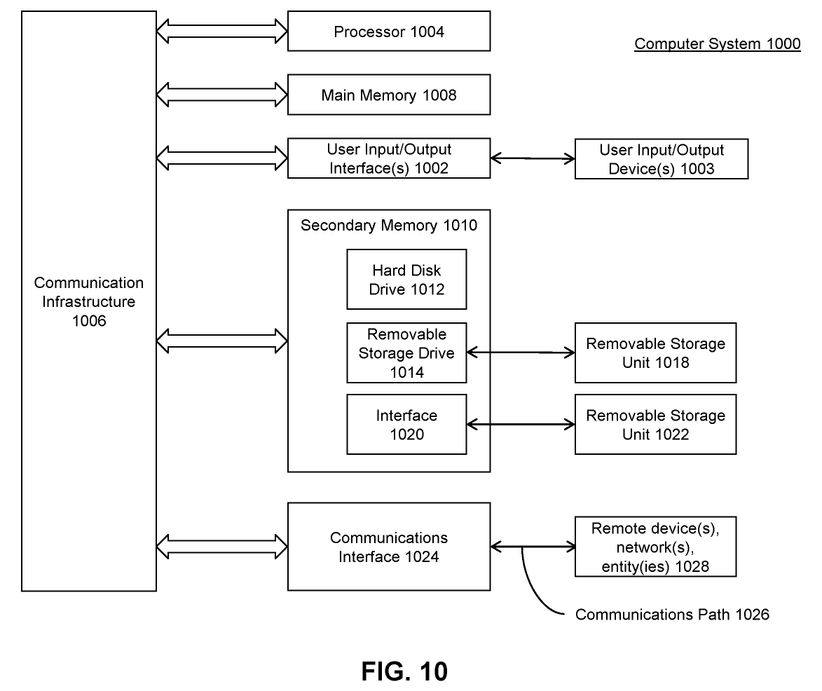

Various aspects may be implemented, for example, using one or more well-known computer systems, such as computer system 1000 shown in FIG. 10. For example, aspects herein using the metadata retrieval system may be implemented using combinations or sub-combinations of computer system 1000. Also or alternatively, one or more computer systems 1000 may be used, for example, to implement any of the aspects discussed herein, as well as combinations and sub-combinations thereof. A “module,” as the term is used herein, is a computational element that performs one or more functions according to computer readable instructions stored on one or more memories or other non-transitory computer-readable media.

Computer system 1000 may include one or more processors (also called central processing units, or CPUs), such as a processor 1004. Processor 1004 may be connected to a communication infrastructure or bus 1006.

Computer system 1000 may also include user input/output device(s) 1003, such as monitors, keyboards, pointing devices, etc., which may communicate with communication infrastructure 1006 through user input/output interface(s) 1002.

One or more of processors 1004 may be a graphics processing unit (GPU). In an aspect, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 1000 may also include a main or primary memory 1008, such as random access memory (RAM). Main memory 1008 may include one or more levels of cache. Main memory 1008 may have stored therein control logic (i.e., computer software) and/or data.

Computer system 1000 may also include one or more secondary storage devices or memory 1010. Secondary memory 1010 may include, for example, a hard disk drive 1012 and/or a removable storage device or drive 1014. Removable storage drive 1014 may be a floppy disk drive, a magnetic tape drive, a compact disk drive, an optical storage device, tape backup device, and/or any other storage device/drive.

Removable storage drive 1014 may interact with a removable storage unit 1018. Removable storage unit 1018 may include a computer usable or readable storage device having stored thereon computer software (control logic) and/or data. Removable storage unit 1018 may be a floppy disk, magnetic tape, compact disk, DVD, optical storage disk, and/ any other computer data storage device. Removable storage drive 1014 may read from and/or write to removable storage unit 1018.

Secondary memory 1010 may include other means, devices, components, instrumentalities or other approaches for allowing computer programs and/or other instructions and/or data to be accessed by computer system 1000. Such means, devices, components, instrumentalities or other approaches may include, for example, a removable storage unit 1022 and an interface 1020. Examples of the removable storage unit 1022 and the interface 1020 may include a program cartridge and cartridge interface (such as that found in video game devices), a removable memory chip (such as an EPROM or PROM) and associated socket, a memory stick and USB or other port, a memory card and associated memory card slot, and/or any other removable storage unit and associated interface.

Computer system 1000 may further include a communication or network interface 1024. Communication interface 1024 may enable computer system 1000 to communicate and interact with any combination of external devices, external networks, external entities, etc. (individually and collectively referenced by reference number 1028). For example, communication interface 1024 may allow computer system 1000 to communicate with external or remote devices 1028 over communications path 1026, which may be wired and/or wireless (or a combination thereof), and which may include any combination of LANs, WANs, the Internet, etc. Control logic and/or data may be transmitted to and from computer system 1000 via communication path 1026.

Computer system 1000 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 1000 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 1000 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some aspects, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 1000, main memory 1008, secondary memory 1010, and removable storage units 1018 and 1022, as well as tangible articles of manufacture embodying any combination of the foregoing. Such control logic, when executed by one or more data processing devices (such as computer system 1000 or processor(s) 1004), may cause such data processing devices to operate as described herein.

Based on the teachings contained in this disclosure, it will be apparent to persons skilled in the relevant art(s) how to make and use aspects of this disclosure using data processing devices, computer systems and/or computer architectures other than that shown in FIG. 10. In particular, aspects can operate with software, hardware, and/or operating system implementations other than those described herein.

It is to be appreciated that the Detailed Description section, and not any other section, is intended to be used to interpret the claims. Other sections can set forth one or more but not all exemplary aspects as contemplated by the inventor(s), and thus, are not intended to limit this disclosure or the appended claims in any way.

While this disclosure describes exemplary aspects for exemplary fields and applications, it should be understood that the disclosure is not limited thereto. Other aspects and modifications thereto are possible, and are within the scope and spirit of this disclosure. For example, and without limiting the generality of this paragraph, aspects are not limited to the software, hardware, firmware, and/or entities illustrated in the figures and/or described herein. Further, aspects (whether or not explicitly described herein) have significant utility to fields and applications beyond the examples described herein.

Aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative aspects can perform functional blocks, steps, operations, methods, etc. using orderings different than those described herein.

References herein to “one aspect,” “an aspect,” “an example aspect,” or similar phrases, indicate that the aspect described may include a particular feature, structure, or characteristic, but every aspect may not necessarily include the particular feature, structure, or characteristic. Moreover, such phrases are not necessarily referring to the same aspect. Further, when a particular feature, structure, or characteristic is described in connection with an aspect, it would be within the knowledge of persons skilled in the relevant art(s) to incorporate such feature, structure, or characteristic into other aspects whether or not explicitly mentioned or described herein. Additionally, some aspects can be described using the expression “coupled” and “connected” along with their derivatives. These terms are not necessarily intended as synonyms for each other. For example, some aspects can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary aspects, but should be defined only in accordance with the following claims and their equivalents.

What is claimed is:

1. A method performed by a credit card, comprising:
receiving, from a point of sale (POS) terminal by a near-field communication (NFC) system embedded into the credit card, an authentication request to authenticate a user associated with a transaction, wherein the transaction occurs when the POS terminal receives credit card information associated with the transaction;
obtaining, from the POS terminal by the NFC system, transaction data associated with the transaction, wherein the transaction data comprises a collection of transaction details associated with the transaction;
receiving, from a motion sensor embedded into the credit card, motion data containing a movement pattern of the user;
generating, by one or more processors of the credit card, a current user profile associated with the user using the transaction data and the motion data;
providing, by the NFC system, the current user profile to a machine learning model to generate a response, wherein the machine learning model is trained on a database storing a historical user profile associated with an owner of the credit card, and wherein the historical user profile comprises historical transaction data and a historical movement pattern of the owner; and
receiving, by the NFC system, the response from the machine learning model, wherein the response indicates whether the user is the owner of the credit card.

2. The method according to claim 1, further comprising:
analyzing, by the one or more processors, the transaction data to identify a fraudulent feature associated with the transaction; and
transmitting, by the NFC system, a request to cause the POS terminal to decline the transaction.

3. The method according to claim 1, further comprising:
analyzing, by the one or more processors, the motion data to identify, as the movement pattern, a specific gesture or a walking style of the user.

4. The method according to claim 1, further comprising:
generating, by the one or more processors, a first embedding associated with the current user profile;
generating, by the one or more processors, a second embedding associated with the historical user profile;
calculating, by the one or more processors, a distance metric between the first embedding and the second embedding; and
identifying, by the one or more processors, the user as the owner of the credit card based on determining the distance metric within a threshold.

5. The method according to claim 4, wherein the first embedding and the second embedding are generated using an embedding model pre-trained on the database.

6. The method according to claim 1, further comprising:
determining, by the one or more processors, whether the database contains the historical user profile associated with the owner of the credit card; and
adding, to the database by the one or more processors, the current user profile based on the database containing the historical user profile, or a default user profile associated with the owner of the credit card based on the database not containing the historical user profile, wherein the current user profile is added when the user is identified as the owner of the credit card.

7. The method according to claim 1, further comprising:
charging, by a wireless charging receiver embedded into the credit card, a battery of the credit card based on converting received alternating current power into direct current power.

8. A system, comprising:
a credit card comprising a motion sensor, a near-field communication (NFC) system, a wireless charging receiver, one or more processors, and a memory;
a point of sale (POS) terminal;
the motion sensor configured to capture motion data of a user, wherein the motion sensor is embedded into the credit card;
the NFC system configured to transmit and receive data between the credit card and the POS terminal, wherein the NFC system is embedded into the credit card;
the wireless charging receiver configured to charge a battery of the credit card, wherein the wireless charging receiver is embedded into the credit card;
the memory configured to store operations; and
the credit card configured to perform the operations, the operations comprising:
receiving, from the POS terminal by the NFC system, an authentication request to authenticate the user associated with a transaction, wherein the transaction occurs when the POS terminal receives credit card information associated with the transaction;
obtaining, from the POS terminal by the NFC system, transaction data associated with the transaction, wherein the transaction data comprises a collection of transaction details associated with the transaction;
receiving, from the motion sensor, the motion data containing a movement pattern of the user;
generating, by the one or more processors, a current user profile associated with the user using the transaction data and the motion data;
providing, by the NFC system, the current user profile to a machine learning model to generate a response, wherein the machine learning model is trained on a database storing a historical user profile associated with an owner of the credit card, and wherein the historical user profile comprises historical transaction data and a historical movement pattern of the owner; and
receiving, by the NFC system, the response from the machine learning model, wherein the response indicates whether the user is the owner of the credit card.

9. The system according to claim 8, wherein the operations further comprise:
analyzing, by the one or more processors, the transaction data to identify a fraudulent feature associated with the transaction; and
transmitting, by the NFC system, a request to cause the POS terminal to decline the transaction.

10. The system according to claim 8, wherein the operations further comprise:
analyzing, by the one or more processors, the motion data to identify, as the movement pattern, a specific gesture or a walking style of the user.

11. The system according to claim 8, wherein the operations further comprise:
generating, by the one or more processors, a first embedding associated with the current user profile;
generating, by the one or more processors, a second embedding associated with the historical user profile;
calculating, by the one or more processors, a distance metric between the first embedding and the second embedding; and
identifying, by the one or more processors, the user as the owner of the credit card based on determining the distance metric within a threshold.

12. The system according to claim 11, wherein the first embedding and the second embedding are generated using an embedding model pre-trained on the database.

13. The system according to claim 8, wherein the operations further comprise:
determining, by the one or more processors, whether the database contains the historical user profile associated with the owner of the credit card; and
adding, to the database by the one or more processors, the current user profile based on the database containing the historical user profile, or a default user profile associated with the owner of the credit card based on the database not containing the historical user profile, wherein the current user profile is added when the user is identified as the owner of the credit card.

14. The system according to claim 8, wherein the operations further comprise:
charging, by the wireless charging receiver, the battery of the credit card based on converting received alternating current power into direct current power.

15. A non-transitory computer-readable storage device having instructions stored thereon, execution of which, by one or more processors of a credit card, causes the credit card to perform operations comprising:
receiving, from a point of sale (POS) terminal by a near-field communication (NFC) system embedded into the credit card, an authentication request to authenticate a user associated with a transaction, wherein the transaction occurs when the POS terminal receives credit card information associated with the transaction;
obtaining, from the POS terminal by the NFC system, transaction data associated with the transaction, wherein the transaction data comprises a collection of transaction details associated with the transaction;
receiving, from a motion sensor embedded into the credit card, motion data containing a movement pattern of the user;
generating, by the one or more processors, a current user profile associated with the user using the transaction data and the motion data;
providing, by the NFC system, the current user profile to a machine learning model to generate a response, wherein the machine learning model is trained on a database storing a historical user profile associated with an owner of the credit card, and wherein the historical user profile comprises historical transaction data and a historical movement pattern of the owner; and
receiving, by the NFC system, the response from the machine learning model, wherein the response indicates whether the user is the owner of the credit card.

16. The non-transitory computer-readable storage device according to claim 15, wherein the operations further comprise:
analyzing, by the one or more processors, the transaction data to identify a fraudulent feature associated with the transaction; and
transmitting, by the NFC system, a request to cause the POS terminal to decline the transaction.

17. The non-transitory computer-readable storage device according to claim 15, wherein the operations further comprise:
generating, by the one or more processors, a first embedding associated with the current user profile;
generating, by the one or more processors, a second embedding associated with the historical user profile;
calculating, by the one or more processors, a distance metric between the first embedding and the second embedding; and
identifying, by the one or more processors, the user as the owner of the credit card based on determining the distance metric within a threshold.

18. The non-transitory computer-readable storage device according to claim 17, wherein the first embedding and the second embedding are generated using an embedding model pre-trained on the database.

19. The non-transitory computer-readable storage device according to claim 15, wherein the operations further comprise:
determining, by the one or more processors, whether the database contains the historical user profile associated with the owner of the credit card; and
adding, to the database by the one or more processors, the current user profile based on the database containing the historical user profile, or a default user profile associated with the owner of the credit card based on the database not containing the historical user profile, wherein the current user profile is added when the user is identified as the owner of the credit card.

20. The non-transitory computer-readable storage device according to claim 15, wherein the operations further comprise:
charging, by a wireless charging receiver embedded into the credit card, a battery of the credit card based on converting received alternating current power into direct current power.
